(19) United States
(12) Patent Application Publication
(10) Pub. No.: US 2024/0028374 A1
(43) Pub. Date: Jan. 25, 2024

(54) METHODS AND APPARATUS TO MONITOR CLOUD RESOURCES WITH A LIGHTWEIGHT COLLECTOR

(71) Applicant: VMWARE, INC., Pala Alto, CA (US)

(72) Inventors: RAHUL SINGH, Bangalore (IN); VINOTHKUMAR D, Bangalore (IN); ABHISHEK SINGH, Bangalore (IN); BHUVANESWARI ADDANKI, Bangalore (IN); ATREYEE BHADURI, Bangalore (IN)

(21) Appl. No.: 17/976,916

(22) Filed: Oct. 31, 2022

(30) Foreign Application Priority Data
Jul. 21, 2022 (IN) 202241041880

(51) Int. Cl. G06F 9/455

(52) U.S. Cl. CPC G06F 9/45558; G06F 2009/45595; G06F 2009/4557

(57) ABSTRACT

Methods, apparatus, systems, and articles of manufacture are disclosed. An example apparatus includes: at least one memory; instructions; and processor circuitry to execute the instructions to: install an agent on a virtual machine, the agent execute as a serverless application in a cloud infrastructure; obtain first metrics from the virtual machine, the first metrics based on an operating system executing on the virtual machine; configure a plug-in of the agent to facilitate the agent monitoring an application executing on the virtual machine; obtain second metrics from the virtual machine, the second metrics based on the application; parse the first and second metrics; and transmit the first and second metrics to a server for storage and analysis.

### RELATED APPLICATIONS

Benefit is claimed under 35 U.S.C. 119(a)-(d) to Foreign Application Serial No. 202241041880 filed in India entitled “METHODS AND APPARATUS TO MONITOR CLOUD RESOURCES WITH A LIGHTWEIGHT COLLECTOR”, on Jul. 21, 2022, by VMware, Inc., which is herein incorporated in its entirety by reference for all purposes.

### FIELD OF THE DISCLOSURE

This disclosure relates generally to cloud resources and, more particularly, to methods and apparatus to monitor cloud resources with a lightweight collector.

### BACKGROUND

Cloud servers include compute, memory, and storage resources to remotely perform services and functions. In recent years, increasingly large and complex computational workloads have been deployed to cloud servers. Previously, such workloads would be executed on-premises, simplifying monitoring and management.

### BRIEF DESCRIPTION OF THE DRAWINGS

FIG. 1 is a block diagram of an example system for implementing a virtualized environment.

FIG. 2 is a block diagram of an example system for lightweight remote monitoring of cloud resources.

FIG. 3 is a block diagram of an example implementation of the lightweight remote collector circuitry of FIG. 1 and/or FIG. 2.

FIG. 4 is an example sequence diagram of lightweight remote monitoring of cloud resources.

FIG. 5 is a flowchart representative of example machine readable instructions and/or example operations that may be executed by example processor circuitry to implement the lightweight remote collector circuitry of FIG. 3.

FIG. 6 is a flowchart representative of example machine readable instructions and/or example operations that may be executed by example processor circuitry to implement the server of FIG. 2.

FIG. 7 is a block diagram of an example processing platform including processor circuitry structured to execute the example machine readable instructions and/or the example operations of FIGS. 5-6 to implement the lightweight remote collector circuitry of FIG. 3.

FIG. 8 is a block diagram of an example implementation of the processor circuitry of FIG. 7.

FIG. 9 is a block diagram of another example implementation of the processor circuitry of FIG. 7.

FIG. 10 is a block diagram of an example software distribution platform (e.g., one or more servers) to distribute software (e.g., software corresponding to the example machine readable instructions of FIGS. 5-6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

Notwithstanding the foregoing, in the case of a semiconductor device, “above” is not with reference to Earth, but instead is with reference to a bulk region of a base semiconductor substrate (e.g., a semiconductor wafer) on which components of an integrated circuit are formed. Specifically, as used herein, a first component of an integrated circuit is “above” a second component when the first component is farther away from the bulk region of the semiconductor substrate than the second component.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real-world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

Public cloud platforms have revolutionized hardware procurement, maintenance, and workspace operations for end users. Yet, such advancements are associated with significant costs, as service providers often charge based on service usage and service type.

To avoid unnecessary costs, end users often carefully monitor cloud resource usage. Conventional tools to monitor cloud resources are often limited to a specific cloud service provider. Some solutions attempt to generalize this process using, for example, management packs that allow component reuse. Yet, even with management packs and other features provided by cloud service providers, conventional solutions have many limitations.

A first limitation is that management packs for conventional cloud agnostic monitoring solutions may only support well-known cloud providers. As the number of cloud providers increases, such solutions fail to scale.

Second, performance metrics that can be collected using conventional solutions are restricted to well-known categories/services. User options are limited further when using free tiers for OS metrics. Thus, although users may want to do a deep-dive into key performance application and OS metrics (e.g., for a VM deployed on a public cloud), conventional solutions often do not support such features.

Third, even if public cloud monitoring solutions support custom metrics, cloud service providers often charge per request and/or per megabyte. Depending on the cloud provider, this may be costly.

Fourth, conventional application monitoring remote collectors may lack flexibility (e.g., in deployment size). Some conventional solutions include only two sizing configurations and are often directly deployed as a compute instance. Such monitoring involves increased cost, especially when a large compute instance is needed for multiple clouds.

Fifth, there is no lightweight, unified solution for application monitoring across cloud providers. Therefore, a user deploying across multiple clouds must painstakingly monitor each cloud service provider's infrastructure using a specific tool.

Conventional cloud performance monitoring solutions may include OS metrics collection, workload analysis, and action triggering. Some conventional solutions for performance monitoring of cloud resources are provided as a service by cloud providers. Cloud service providers often separate monitoring services into tiers, with lower tiers having limited metrics and monitoring features. Cloud providers charge significantly for additional features and more extensive monitoring of cloud infrastructure. For all the aforementioned reasons, many users seek a cloud agnostic solution to monitor their public cloud infrastructure in a cost-efficient manner.

Examples disclosed herein provide a cloud agnostic and lightweight resource monitor. Disclosed examples provide a cost-effective application monitoring solution across cloud providers. Disclosed examples may collect both detailed operating system and application metrics.

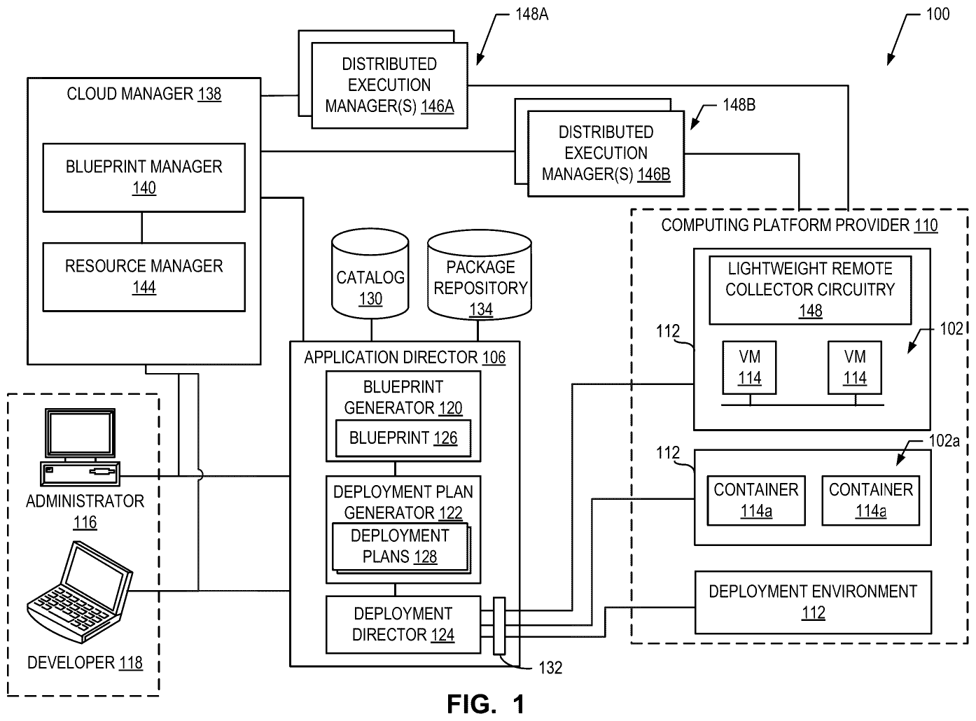

Disclosed examples include at least one lightweight remote collector that is designed to run as a serverless application as shown in FIG. 1. Disclosed examples may be executed as serverless applications to save cost and reduce maintenance overhead. Some examples include a master data node run as a software as a service (SaaS) product, and a remote collector deployed as service on a plurality of public clouds.

FIG. 1 is a block diagram of an example system 100 for implementing a virtualized environment. The example system 100 includes an application director 106 and a cloud manager 138 to manage a computing platform provider 110 as described in more detail below. As described herein, the example system 100 facilitates management of the provider 110 and does not include the provider 110. Alternatively, the system 100 can be included in the provider 110.

The computing platform provider 110 provisions virtual computing resources (e.g., virtual machines, or “VMs,” 114) that may be accessed by users of the computing platform (e.g., users associated with an administrator 116 and/or a developer 118) and/or other programs, software, device. etc.

An example application 102 implemented via the computing platform provider 110 of FIG. 1 includes multiple VMs 114. The example VMs 114 of FIG. 1 provide different functions within the application 102 (e.g., services, portions of the application 102, etc.). One or more of the VMs 114 of the illustrated example are customized by an administrator 116 and/or a developer 118 of the application 102 relative to a stock or out-of-the-box (e.g., commonly available purchased copy) version of the services and/or application components. Additionally, the services executing on the example VMs 114 may have dependencies on other ones of the VMs 114.

As illustrated in FIG. 1, the example computing platform provider 110 may provide multiple deployment environments 112, for example, for development, testing, staging, and/or production of applications. The administrator 116, the developer 118, other programs, and/or other devices may access services from the computing platform provider 110, for example, via REST (Representational State Transfer) APIs (Application Programming Interface) and/or via any other client-server communication protocol. Example implementations of a REST API for cloud and/or other computing services include a vCloud Administrator Center™ (vCAC) and/or vRealize Automation™ (vRA) API and a vCloud Director™ API available from VMware, Inc. The example computing platform provider 110 provisions virtual computing resources (e.g., the VMs 114) to provide the deployment environments 112 in which the administrator 116 and/or the developer 118 can deploy multi-tier application(s). One particular example implementation of a deployment environment that may be used to implement the deployment environments 112 of FIG. 1 is vCloud DataCenter cloud computing services available from VMware, Inc.

In some examples disclosed herein, a lighter-weight virtualization is employed by using containers in place of the VMs 114 in the development environment 112. Example containers 114a are software constructs that run on top of a host operating system without the need for a hypervisor or a separate guest operating system. Unlike virtual machines, the containers 114a do not instantiate their own operating systems. Like virtual machines, the containers 114a are logically separate from one another. Numerous containers can run on a single computer, processor system and/or in the same development environment 112. Like virtual machines, the containers 114a can execute instances of applications or programs (e.g., an example application 102a) separate from application/program instances executed by the other containers in the same development environment 112.

The example application director 106 of FIG. 1, which may be running in one or more VMs, orchestrates deployment of multi-tier applications onto one of the example deployment environments 112. As illustrated in FIG. 1, the example application director 106 includes a blueprint generator 120, a deployment plan generator 122, and a deployment director 124.

The example blueprint generator 120 generates a basic blueprint 126 that specifies a logical topology of an application to be deployed. The example basic blueprint 126 generally captures the structure of an application as a collection of application components executing on virtual computing resources. For example, the basic blueprint 126 generated by the example blueprint generator 120 for an online store application may specify a web application (e.g., in the form of a Java web application archive or “WAR” file including dynamic web pages, static web pages, Java servlets, Java classes, and/or other property, configuration and/or resources files that make up a Java web application) executing on an application server (e.g., Apache Tomcat application server) that uses a database (e.g., MongoDB) as a data store. As used herein, the term “application” generally refers to a logical deployment unit, including one or more application packages and their dependent middleware and/or operating systems. Applications may be distributed across multiple VMs. Thus, in the example described above, the term “application” refers to the entire online store application, including application server and database components, rather than just the web application itself. In some instances, the application may include the underlying hardware and/or virtual computing hardware utilized to implement the components.

The example basic blueprint 126 of FIG. 1 may be assembled from items (e.g., templates) from a catalog 130, which is a listing of available virtual computing resources (e.g., VMs, networking, storage, etc.) that may be provisioned from the computing platform provider 110 and available application components (e.g., software services, scripts, code components, application-specific packages) that may be installed on the provisioned virtual computing resources. The example catalog 130 may be pre-populated and/or customized by an administrator 116 (e.g., IT (Information Technology) or system administrator) that enters in specifications, configurations, properties, and/or other details about items in the catalog 130. Based on the application, the example blueprints 126 may define one or more dependencies between application components to indicate an installation order of the application components during deployment. For example, since a load balancer usually cannot be configured until a web application is up and running, the developer 118 may specify a dependency from an Apache service to an application code package.

The example deployment plan generator 122 of the example application director 106 of FIG. 1 generates a deployment plan 128 based on the basic blueprint 126 that includes deployment settings for the basic blueprint 126 (e.g., virtual computing resources' cluster size, CPU, memory, networks, etc.) and an execution plan of tasks having a specified order in which virtual computing resources are provisioned and application components are installed, configured, and started. The example deployment plan 128 of FIG. 1 provides an IT administrator with a process-oriented view of the basic blueprint 126 that indicates discrete actions to be performed to deploy the application. Different deployment plans 128 may be generated from a single basic blueprint 126 to test prototypes (e.g., new application versions), to scale up and/or scale down deployments, and/or to deploy the application to different deployment environments 112 (e.g., testing, staging, production). The deployment plan 128 is separated and distributed as local deployment plans having a series of tasks to be executed by the VMs 114 provisioned from the deployment environment 112. Each VM 114 coordinates execution of each task with a centralized deployment module (e.g., the deployment director 124) to ensure that tasks are executed in an order that complies with dependencies specified in the application blueprint 126.

The example deployment director 124 of FIG. 1 executes the deployment plan 128 by communicating with the computing platform provider 110 via an interface 132 to provision and configure the VMs 114 in the deployment environment 112. The example interface 132 of FIG. 1 provides a communication abstraction layer by which the application director 106 may communicate with a heterogeneous mixture of provider 110 and deployment environments 112. The deployment director 124 provides each VM 114 with a series of tasks specific to the receiving VM 114 (herein referred to as a “local deployment plan”). Tasks are executed by the VMs 114 to install, configure, and/or start one or more application components. For example, a task may be a script that, when executed by a VM 114, causes the VM 114 to retrieve and install particular software packages from a central package repository 134. The example deployment director 124 coordinates with the VMs 114 to execute the tasks in an order that observes installation dependencies between VMs 114 according to the deployment plan 128. After the application has been deployed, the application director 106 may be utilized to monitor and/or modify (e.g., scale) the deployment.

The example cloud manager 138 of FIG. 1 interacts with the components of the system 100 (e.g., the application director 106 and the provider 110) to facilitate the management of the resources of the provider 110. The example manager 138 includes a blueprint manager 140 to facilitate the creation and management of multi-machine blueprints and a resource manager 144 to reclaim unused cloud resources. The manager 138 may additionally include other components for managing a cloud environment.

The example blueprint manager 140 of the illustrated example manages the creation of multi-machine blueprints that define the attributes of multiple virtual machines as a single group that can be provisioned, deployed, managed, etc. as a single unit. For example, a multi-machine blueprint may include definitions for multiple basic blueprints that make up a service (e.g., an e-commerce provider that includes web servers, application servers, and database servers). A basic blueprint is a definition of policies (e.g., hardware policies, security policies, network policies, etc.) for a single machine (e.g., a single virtual machine such as a web server virtual machine and/or container). Accordingly, the blueprint manager 140 facilitates more efficient management of multiple virtual machines and/or containers than manually managing (e.g., deploying) basic blueprints individually.

The example blueprint manager 140 of FIG. 1 additionally annotates basic blueprints and/or multi-machine blueprints to control how workflows associated with the basic blueprints and/or multi-machine blueprints are executed. As used herein, a workflow is a series of actions and decisions to be executed in a virtual computing platform. The example system 100 includes first and second distributed execution manager(s) (DEM(s)) 146A and 146B to execute workflows. According to the illustrated example, the first DEM 146A includes a first set of characteristics and is physically located at a first location 148A. The second DEM 146B includes a second set of characteristics and is physically located at a second location 148B. The location and characteristics of a DEM may make that DEM more suitable for performing certain workflows. For example, a DEM may include hardware particularly suited for performance of certain tasks (e.g., high-end calculations), may be located in a desired area (e.g., for compliance with local laws that require certain operations to be physically performed within a country's boundaries), may specify a location or distance to other DEMS for selecting a nearby DEM (e.g., for reducing data transmission latency), etc. Thus, the example blueprint manager 140 annotates basic blueprints and/or multi-machine blueprints with capabilities that can be performed by a DEM that is labeled with the same or similar capabilities.

The resource manager 144 of the illustrated example facilitates recovery of computing resources of the provider 110 that are no longer being activity utilized. Automated reclamation may include identification, verification and/or reclamation of unused, underutilized, etc. resources to improve the efficiency of the running cloud infrastructure.

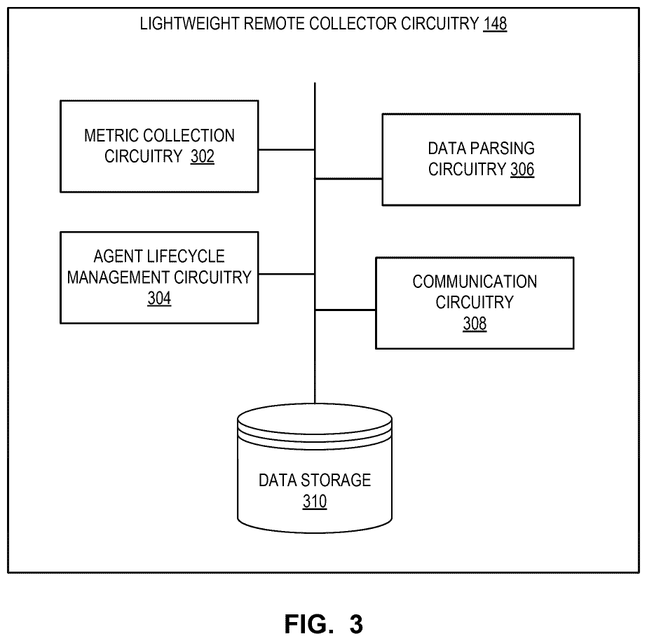

The system 100 additionally includes the example lightweight remote collector circuitry 148. The lightweight remote collector circuitry 148 may be deployed in a cloud environment of the computing platform provider 110. In some examples, the lightweight remote collector circuitry 148 may be run as a serverless SaaS program and manage an agent. Management of the agent may include initialization of the agent, configuration of the agent, retrieval of data from the agent, etc. The structure and function of the example lightweight remote collector circuitry 148 will be described in greater detail in association with FIG. 3.

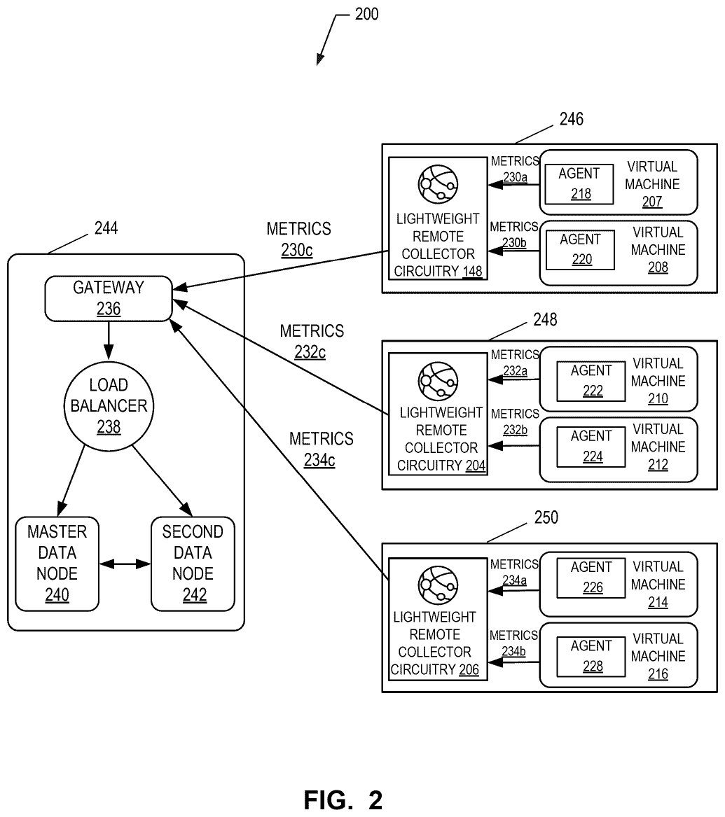

FIG. 2 is an illustration of a second system 200 that can monitor cloud resources across heterogenous cloud infrastructures. The system 200 includes the first lightweight remote collector circuitry 148, second lightweight remote collector circuitry 204, third lightweight remote collector circuitry 206, a first virtual machine 207, a second virtual machine 208, a third virtual machine 210, a fourth virtual machine 212, a fifth virtual machine 214, a sixth virtual machine 216, a first agent 218, a second agent 220, a third agent 222, a fourth agent 224, a fifth agent 226, a sixth agent 228, first metrics 230a-c, second metrics 232a-c, third metrics 234a-b, a gateway 236, a load balancer 238, a master data node 240, a second data node 242, and an example server 244.

The example server 244 includes the gateway 236, the load balancer 238, the master data node 240, and the example second data node 242. The example server 244 may be a cloud server and/or an on-premises server. In some examples, the example server 244 may be a hybrid server with some members of the server 244 on-premises and some members in the cloud.

The example server 244 may include cloud management software to manage a plurality of cloud workloads executing on a plurality of cloud resource providers. The example gateway 236 retrieves metric information from an example first cloud resource infrastructure 246, an example second cloud resource infrastructure 248, and an example third cloud resource infrastructure 250. The example metrics 230c, 232c, and 234c are retrieved and processed by the gateway 236 and transmitted to the example load balancer 238 to be transmitted to the master data node 240 and the data node 242.

The example master data node 240 provides a single point of control for the example second system 200. The master data node 240 can command the example lightweight remote collector circuitry 148, the example second lightweight remote collector circuitry 204, and/or the example third lightweight remote collector circuitry 206 to perform lifecycle management of the example agents 218-228. Lifecycle management and configuration (e.g., on each respective virtual machine 207-216) may include install, start, stop, upgrade, and uninstall of agents. The example master data node 240 may also monitor any specific application permissions for the example agents 218-228. Credentials are provided to the example master data node 240 for respective virtual machine(s) 207-216 during install of agents on the respective virtual machine(s) 207-216. If the example agents 218-228 are deployed during provisioning, the agents 218-228 can be deployed in a default configuration without credentials.

The example second data node 242 is a duplicate node (e.g., a replica data node) of the master data node 240. The master data node 240 stores metric data, and the data node 242 receives and stores identical data. Thus, in situations in which the master data node 240 becomes unavailable, the example second data node 242 can perform the same functions as the master data node (e.g., store the metric data).

The example first cloud resource infrastructure 246, the example second cloud resource infrastructure 248, and the example third cloud resource infrastructure 250 are separate infrastructures that are provided by separate cloud infrastructure providers. For example, the first cloud resource infrastructure 246 may be maintained by a first cloud infrastructure provider, the second cloud resource infrastructure 248 may be maintained by a second cloud infrastructure provider, and the third cloud resource infrastructure 250 may be maintained by a third cloud infrastructure provider. Each cloud resource infrastructure is provided an instance of the example lightweight remote collector circuitry (e.g., the first cloud resource infrastructure 246 is provided the example first lightweight remote collector circuitry 148). The example first lightweight remote collector circuitry 148 collects metrics from the example first agent 218 and the example second agent 220. The example first lightweight remote collector circuitry 148 will be described in further detail in association with FIG. 3.

The example first lightweight remote collector circuitry 148, the example second lightweight remote collector circuitry 204, and the example third lightweight collector circuitry 206 are three instantiations of substantially similar software. Thus, the example lightweight remote collector circuitry 148, 204, 206 is platform agnostic and can be deployed on any type of cloud infrastructure through configuration of a single set of instructions.

The example cloud infrastructure 246 includes the example first lightweight remote collector circuitry 148 that collects first metrics 230a from the example first agent and collects second metrics 230b from the example second agent 220. The example first agent 218 is executed on the example first virtual machine 207. The example second agent 220 is executed on the example second virtual machine 208. The example first agent 218 executes on the first virtual machine 207, and therefore the first agent 218 does not need any network connection to monitor the operations of the example first virtual machine 207. The cloud infrastructure 246 may include one or more servers that are hosted by a cloud resource provider. In some examples, hypervisor software may connect and virtualize multiple physical servers, pooling the combined resources to generate a virtual server with a compute capabilities greater than any individual server. In some examples, the cloud infrastructure 246 may include a dedicated server that is provided to a user by the cloud service provider. The one or more servers may receive instructions over a network to execute a workload on the first virtual machine 207 and/or the second virtual machine, execute the workload, and/or transmit results to a user over the network.

The example first agent 218 monitors the operating system functions of the example first virtual machine 207. The example first agent 218 additionally may monitor applications executing on the first virtual machine. For example, the first agent 218 may monitor operating system processes and database metrics for the example first virtual machine 207. The example metrics may be transmitted to the example first lightweight remote collector circuitry 148 by the example first agent 218. The example lightweight remote collector circuitry 148 may then parse the metrics and send the metrics to the example server 244.

The example system 200 includes the second cloud infrastructure 248 with associated second lightweight remote collector circuitry 204, third agent 222, and fourth agent 224. Thus, third metrics 232a-c may be collected from the second cloud infrastructure 248 by the example second lightweight remote collector circuitry 204.

The example second through sixth agents 220-228 perform similar functions to the example first agent. However, differences arise due to features of each specific infrastructure the agent(s) executes on. For example, the example second cloud infrastructure 248 may be operated by a different cloud infrastructure provider than the example first cloud infrastructure 246. Similarly, the example third virtual machine 210 may be executing a different operating system than either the example first virtual machine 207 or the example second virtual machine 208. However, the respective metric data (e.g., third metrics 232 for the second infrastructure 248, fourth metrics 234 for third infrastructure 250) may be parsed by each respective lightweight remote collector to provide a consistent output. Therefore, the example metrics 230c, 232c and 234c may be transmitted to the example server 244 in a consistent format. In some examples, metric collection and forwarding occurs at regular collection intervals.

FIG. 3 is a block diagram of an example implementation of the lightweight remote collector circuitry 148 to monitor cloud resources with a lightweight collector. The lightweight remote collector circuitry 148 of FIG. 3 may be instantiated (e.g., creating an instance of, bring into being for any length of time, materialize, implement, etc.) by processor circuitry such as a central processing unit executing instructions. Additionally or alternatively, lightweight remote collector circuitry 148 of FIG. 3 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 3 may, thus, be instantiated at the same or different times. Some or all of the circuitry may be instantiated, for example, in one or more threads executing concurrently on hardware and/or in series on hardware. Moreover, in some examples, some or all of the circuitry of FIG. 3 may be implemented by microprocessor circuitry executing instructions to implement one or more virtual machines and/or containers.

The example lightweight remote collector circuitry 148 includes example metric collection circuitry 302, example agent lifecycle management circuitry 304, example data parsing circuitry 306, example communication circuitry 308, and example data storage 310.

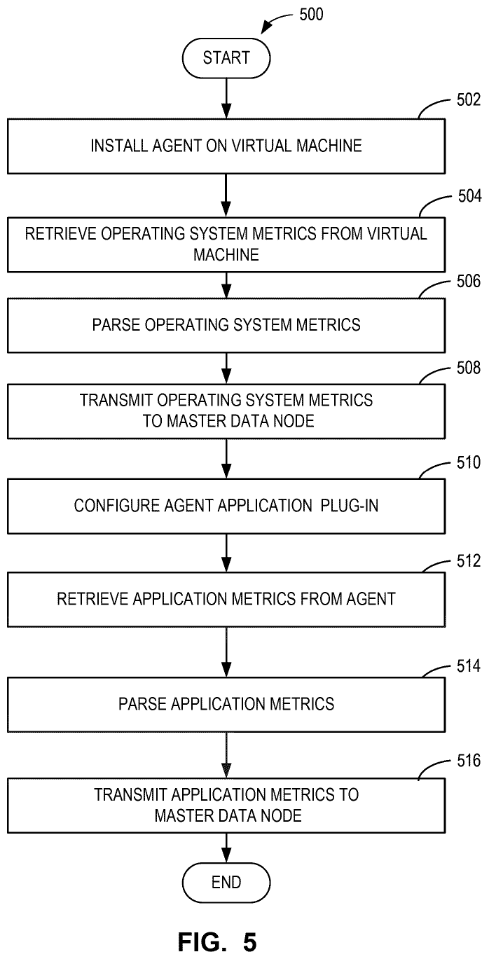

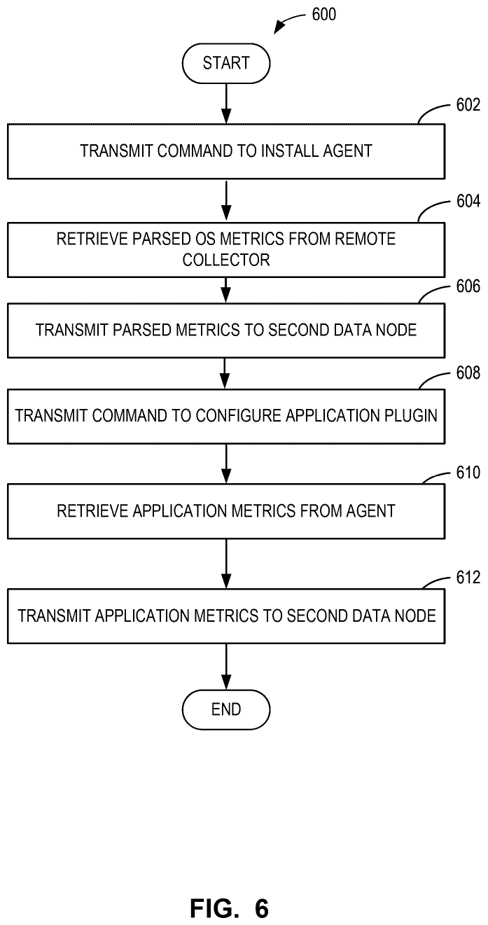

The example lightweight remote collector circuitry 148 includes the metric collection circuitry 302. The example metric collection circuitry 302 gathers metric information from an agent that is deployed to a virtual machine. The metric collection circuitry 302 may collect metrics from the agent at regular intervals (e.g., once every five minutes, once every hour, once a week, etc.). In some examples, the metric collection circuitry 302 collects data from a plurality of agents operating on a similar cloud infrastructure. The metric collection circuitry 302 additionally forwards the collected data to a server for further analysis, storage, etc. In some examples, the metric collection circuitry 302 is instantiated by processor circuitry executing metric collection instructions and/or configured to perform operations such as those represented by the flowchart of FIGS. 5-6.

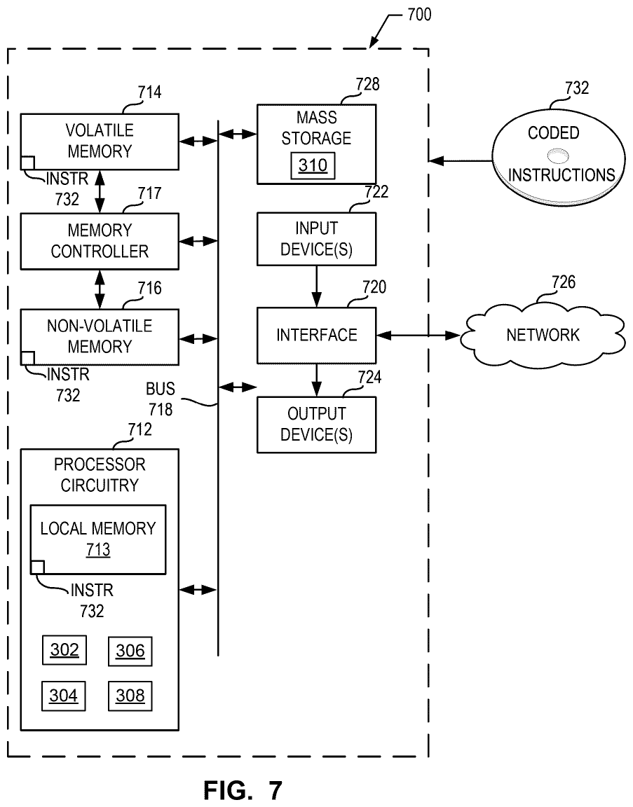

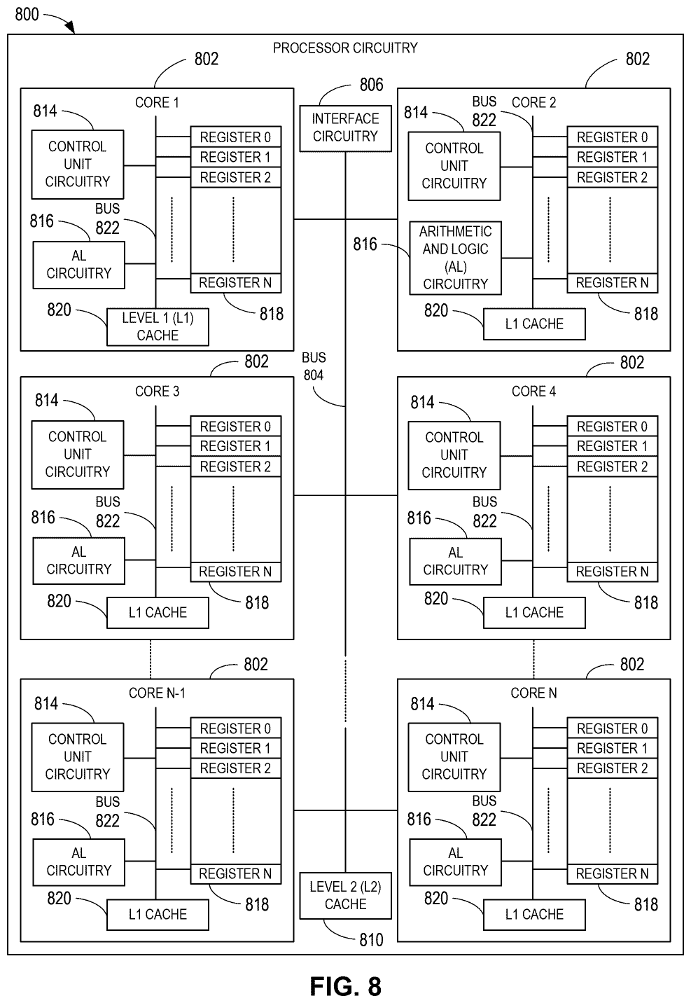

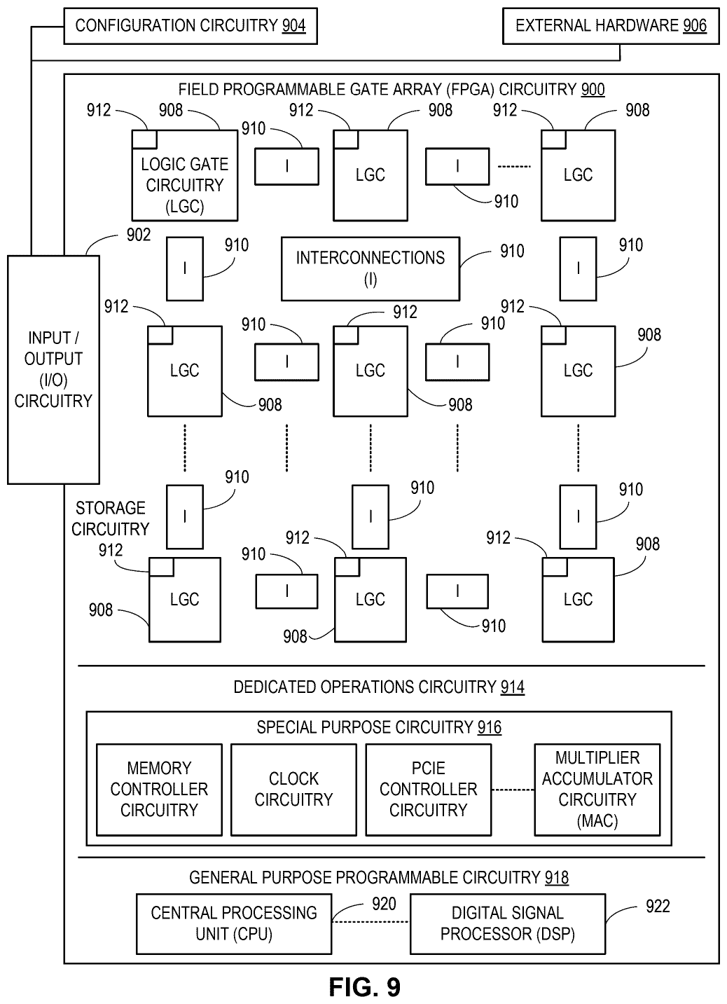

In some examples, the lightweight remote collector circuitry 148 includes means for collecting first and second metrics from an agent executing on a virtual machine. For example, the means for determining may be implemented by metric collection circuitry 302. In some examples, the metric collection circuitry 302 may be instantiated by processor circuitry such as the example processor circuitry 712 of FIG. 7. For instance, the metric collection circuitry 302 may be instantiated by the example microprocessor 800 of FIG. 8 executing machine executable instructions such as those implemented by at least blocks 702, 704 of FIG. 7. In some examples, the metric collection circuitry 302 may be instantiated by hardware logic circuitry, which may be implemented by an ASIC, XPU, or the FPGA circuitry 900 of FIG. 9 structured to perform operations corresponding to the machine readable instructions. Additionally or alternatively, the metric collection circuitry 302 may be instantiated by any other combination of hardware, software, and/or firmware. For example, the metric collection circuitry 302 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example lightweight remote collector circuitry 148 includes the agent lifecycle management circuitry 304. The example agent lifecycle management circuitry 304 installs, starts, stops, upgrades, and uninstall agents. For example, the agent lifecycle management circuitry 304 may install an agent on a virtual machine to monitor and collect resources executing on the virtual machine (e.g., OS and/or application metrics). The lifecycle management circuitry 304 may initialize the agent and/or provide the agent instructions to pause collection for a period of time. For example, the lifecycle management circuitry 304 may instruct the agent to continually collect operating system metrics, while only collecting application metrics at specific times (e.g., during heavy workloads, during scheduled workloads, in response to a request for service, etc.).

The example agent lifecycle management circuitry 304 can perform upgrades to the agent. For example, the agent may be upgraded to include enhanced metric collection capabilities, reduce a footprint of the agent, etc. In some examples, the agent lifecycle management circuitry 304 is instantiated by processor circuitry executing metric collection instructions and/or configured to perform operations such as those represented by the flowchart of FIG. 8.

In some examples, the lightweight remote collector circuitry 148 includes means for managing a lifecycle of an agent installed on a virtual machine. For example, the means for managing may be implemented by agent lifecycle management circuitry 304. In some examples, the agent lifecycle management circuitry 304 may be instantiated by processor circuitry such as the example processor circuitry 712 of FIG. 7. For instance, the agent lifecycle management circuitry 304 may be instantiated by the example microprocessor 800 of FIG. 8 executing machine executable instructions such as those implemented by at least blocks 702, 704 of FIG. 7. In some examples, agent lifecycle management circuitry 304 may be instantiated by hardware logic circuitry, which may be implemented by an ASIC, XPU, or the FPGA circuitry 900 of FIG. 9 structured to perform operations corresponding to the machine readable instructions. Additionally or alternatively, the agent lifecycle management circuitry 304 may be instantiated by any other combination of hardware, software, and/or firmware. For example, the agent lifecycle management circuitry 304 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate

The example lightweight remote collector circuitry 148 includes the example data parsing circuitry 306. The example data parsing circuitry 306 parses data from example virtual machines and generates data in a format suitable for analysis by an example server.

The data parsing circuitry 306 may retrieve data from an agent executing on a virtual machine (e.g., data retrieved by the communication circuitry 308) and parse the data. The parsed data is then reformatted into a consistent format (e.g., JavaScript object notation format, comma-separated value format, etc.).

In some examples, the data parsing circuitry 306 is instantiated by processor circuitry executing metric collection instructions and/or configured to perform operations such as those represented by the flowchart of FIG. 8.

In some examples, the lightweight remote collector circuitry 148 includes means for parsing data and generating output data in a structured format. For example, the means for parsing may be implemented by the data parsing circuitry 306. In some examples, data parsing circuitry 306 may be instantiated by processor circuitry such as the example processor circuitry 712 of FIG. 7. For instance, the data parsing circuitry 306 may be instantiated by the example microprocessor 800 of FIG. 8 executing machine executable instructions such as those implemented by at least blocks 702, 704 of FIG. 7. In some examples, data parsing circuitry 306 may be instantiated by hardware logic circuitry, which may be implemented by an ASIC, XPU, or the FPGA circuitry 900 of FIG. 9 structured to perform operations corresponding to the machine readable instructions. Additionally or alternatively, the data parsing circuitry 306 may be instantiated by any other combination of hardware, software, and/or firmware. For example, the data parsing circuitry 306 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate

The example lightweight remote collector circuitry 148 includes the example communication circuitry 308. The example communication circuitry 308 facilitates communication to/from the example virtual machine 207 and/or the example master data node 240. The communication circuitry 308 may retrieve data from the virtual machine by communicating with an agent executing on a virtual machine. In some examples, the communication circuitry 308 may retrieve data from a plurality of agents.

In some examples, the communication circuitry 308 is instantiated by processor circuitry executing metric collection instructions and/or configured to perform operations such as those represented by the flowchart of FIG. 8.

In some examples, the lightweight remote collector circuitry 148 includes means for receiving and/or transmitting data from a virtual machine and/or a server. For example, the means for transmitting may be implemented by the example communication circuitry 308. In some examples, example communication circuitry 308 may be instantiated by processor circuitry such as the example processor circuitry 712 of FIG. 7. For instance, the example communication circuitry 308 may be instantiated by the example microprocessor 800 of FIG. 8 executing machine executable instructions such as those implemented by at least blocks 702, 704 of FIG. 7. In some examples, the example communication circuitry 308 may be instantiated by hardware logic circuitry, which may be implemented by an ASIC, XPU, or the FPGA circuitry 900 of FIG. 9 structured to perform operations corresponding to the machine readable instructions. Additionally or alternatively, the example communication circuitry 308 may be instantiated by any other combination of hardware, software, and/or firmware. For example, the example communication circuitry 308 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate

In some examples, the lightweight remote collector circuitry 148 includes the example data storage 310. The example data storage 310 stores metrics and/or analytic data retrieved from a virtual machine (e.g., the example virtual machine 207). However, in some examples, the lightweight remote collector circuitry 148 is executed as a serverless function and data is not stored in the cloud. In such an example, the lightweight remote collector circuitry 148 does not include the data storage 310, instead transmitting information directly to the server 244. In some examples, the data storage 310 is instantiated by processor circuitry executing metric collection instructions and/or configured to perform operations such as those represented by the flowchart of FIG. 8.

In some examples, the lightweight remote collector circuitry 148 includes means for storing metric data. For example, the means for storing may be implemented by the example data storage 310. In some examples, the data storage 310 may be instantiated by processor circuitry such as the example processor circuitry 712 of FIG. 7. For instance, the example data storage 310 may be instantiated by the example microprocessor 800 of FIG. 8 executing machine executable instructions such as those implemented by at least blocks 702, 704 of FIG. 7. In some examples, the example data storage 310 may be instantiated by hardware logic circuitry, which may be implemented by an ASIC, XPU, or the FPGA circuitry 900 of FIG. 9 structured to perform operations corresponding to the machine readable instructions. Additionally or alternatively, the data storage 310 may be instantiated by any other combination of hardware, software, and/or firmware. For example, the data storage 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate

While an example manner of implementing the lightweight remote collector circuitry 148 of FIG. 1 is illustrated in FIG. 3, one or more of the elements, processes, and/or devices illustrated in FIG. 3 may be combined, divided, re-arranged, omitted, eliminated, and/or implemented in any other way. Further, the example metric collection circuitry 302, the example agent lifecycle management circuitry 304, the example data parsing circuitry 306, the example communication circuitry 308, the example data storage 310, and/or the example lightweight remote collector circuitry 148 of FIG. 1, may be implemented by hardware alone or by hardware in combination with software and/or firmware. Thus, for example, any of the example metric collection circuitry 302, the example agent lifecycle management circuitry 304, the example data parsing circuitry 306, the example communication circuitry 308, the example data storage 310, and/or the example lightweight remote collector circuitry 148 of FIG. 1, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example lightweight remote collector circuitry 148 of FIG. 1 may include one or more elements, processes, and/or devices in addition to, or instead of, those illustrated in FIG. 3, and/or may include more than one of any or all of the illustrated elements, processes and devices.

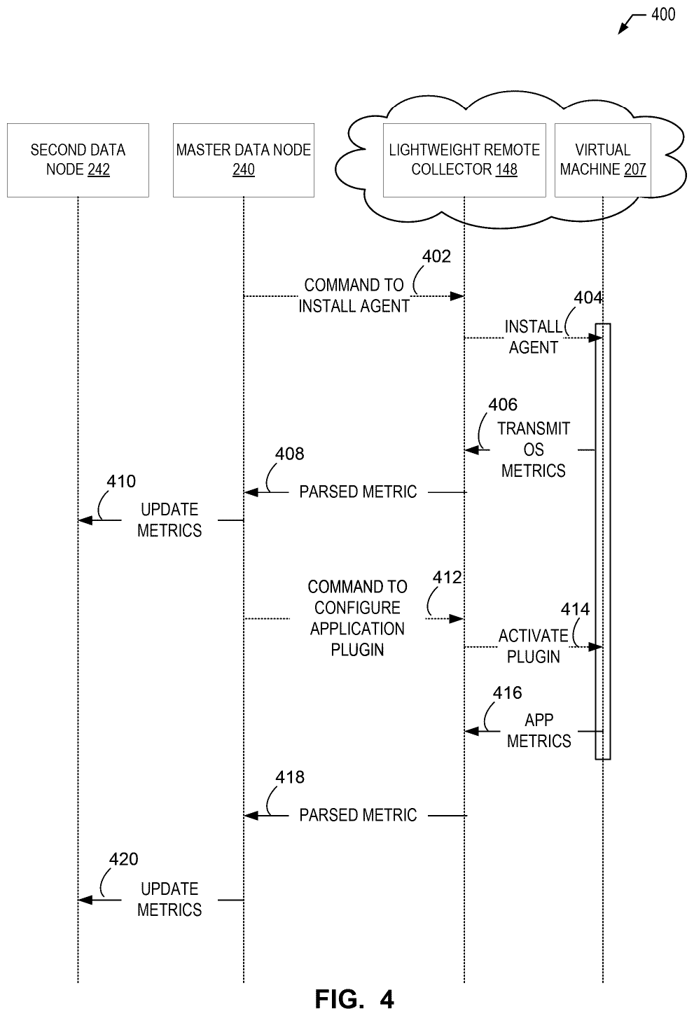

FIG. 4 is an example sequence diagram 400 of lightweight remote monitoring of cloud resources. The example sequence diagram 400 includes the example second data node 242 of FIG. 2, the example master data node 240 of FIG. 2, the example lightweight remote collector 148 of FIG. 2, and the example virtual machine 207 of FIG. 2.

The sequence diagram 400 starts at an example first arrow 402, at which the example master data node 240 generates a command to install an agent to the example lightweight remote collector 148. For example, the master data node 240 may include a graphical user interface for a user to interact with, provide commands, analyze metric data, virtual machines, etc. The graphical user interface may include a feature that generates a command to install an agent on a virtual machine. The graphical user interface and/or any other interface associated with the master data node 240 may include management features for a plurality of cloud resources distributed across cloud and/or hybrid resources associated with multiple cloud resource providers.

At a second arrow 404, the example lightweight remote collector 148 installs an agent on the virtual machine 207. The lightweight remote collector 148 installs an agent to collect OS and application metrics. In some examples, the lightweight remote collector 148 may install more than one agent on a virtual machine. For example, a first agent may collect application data, a second agent collects operating system data, and a third agent collects hardware associated with the virtual machine 207.

The example agent retrieves OS metrics from the virtual machine 207, which are transmitted to the example lightweight remote collector 148 at a third arrow 406. The lightweight remote collector 148 parses the OS metrics and transmits the metrics to the master data node 240 at a fourth arrow 408. In some examples, the lightweight remote collector 148 may parse metrics from a plurality of agents and reformat the data for transmission to the master data node 240. Parsing and reformatting of data allows the master data node 240 to easily manage and/or perform analytics on heterogenous and/or hybrid cloud infrastructures. For example, a first agent may be installed on the virtual machine 207, and a second agent may be installed on a second virtual machine, the second virtual machine executing a different operating system than the first virtual machine. By parsing the collected data (e.g., scanning for specific data, discarding unnecessary data) the lightweight remote collector circuitry 148 provides a consistent output to the master data node 240.

At a fifth arrow 410, the master data node 240 sends updated metrics to the second data node 242 to generate a backup (e.g., master data node 240 is in high availability mode). The second data node 242 may work with the master data node 240 in a fault-tolerant mode, in which the second data node can replace the master data node 240 in the event of an unexpected event (e.g., system failure, error, data loss).

The example master data node 240 next generates a command to be sent to the example lightweight remote collector 148 to configure an application plug-in at sixth arrow 412. The lightweight remote collector 148 configures a plug-in on the agent to allow the agent to monitor application data. The agent uses the configured plug-in to interoperate and collect metric data from an application executing on the virtual machine 207. For example, the plug-in may be related to a database application. Configuration parameters for an example database application may include a port identifier, a user credential, a database key, etc.

The example lightweight remote collector 148 activates the plug-in at seventh arrow 414. The example virtual machine 207 then retrieves data, via the plug-in, of the application for which the plug-in was installed (e.g., the database application).

At arrow 416, the example virtual machine 207 transmits application metrics (e.g., from the database application) to the example lightweight remote collector 148. The parsed metrics are parsed by the example lightweight remote collector 148 before being transmitted to the master data node at a ninth arrow 418. At a tenth arrow 420, the example master data node sends the parsed app metric data to the example second data node 242 for backup.

A flowchart representative of example machine readable instructions, which may be executed to configure processor circuitry to implement the lightweight remote collector circuitry 148 of FIG. 2, is shown in FIGS. 5 and 6. The machine readable instructions may be one or more executable programs or portion(s) of an executable program for execution by processor circuitry, such as the processor circuitry 712 shown in the example processor platform 700 discussed below in connection with FIG. 7 and/or the example processor circuitry discussed below in connection with FIGS. 8 and/or 9. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 5 and 6, many other methods of implementing the example lightweight remote collector circuitry 148 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 5-6 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 5 is a flowchart representative of example machine readable instructions and/or example operations 500 that may be executed and/or instantiated by processor circuitry to monitor cloud resources with the lightweight collector 148 of FIG. 3.

The machine readable instructions and/or the operations 500 of FIG. 5 begin at block 502, at which the agent lifecycle management circuitry 304 of FIG. 3 installs an agent on a virtual machine. For example, the agent lifecycle management circuitry 304 of FIG. 3 may install an agent on a virtual machine executing in a cloud infrastructure, the agent to transmit information to a serverless application executing in the cloud infrastructure.

At block 504, the example communication circuitry 308 of FIG. 3 retrieves operating system metrics from the virtual machine. For example, the operating system metrics may include memory usage, CPU usage, disk usage, network latency, etc. The metric data is collected from the first virtual machine at a consistent interval.

Then, at block 506 the example data parsing circuitry 306 of FIG. 3 parses the operating system metrics. For example, the data parsing circuitry 306 of FIG. 3 may format the operating system data in JSON to generate a structured analytic data that can be transmitted to a master data node.

At block 508, the example communication circuitry 308 of FIG. 3 transmits the operating system metrics to the master data node. Next, at block 510, the example agent lifecycle management circuitry 304 of FIG. 3 configures an agent application plug-in. For example, configuring an agent application plug-in may include providing the agent a port identifier, a user credential, and a database key.

At block 512, the example communication circuitry 308 retrieves application metrics from the agent (e.g., at specified intervals). At block 514, the example data parsing circuitry 306 of FIG. 3 parses the application metrics. In some examples, the data parsing circuitry 306 may parse the operating system metrics and the application metrics together to generate structured analytic data that is in a consistent format.

At block 516 the example communication circuitry 308 of FIG. 3 transmits the application metrics to a master data node.

FIG. 6 is a flowchart representative of example machine readable instructions and/or example operations 600 that may be executed and/or instantiated by processor circuitry to monitor cloud resources with the lightweight collector 148 of FIG. 3. The example instructions 600 begin at block 602, at which the example master data node 240 transmits a command to install an agent. In some examples, the master data node 240 may transmit a plurality of commands to install a plurality of agents across diverse cloud infrastructures. The various cloud infrastructures may be operated by various different cloud providers. At block 604, the example master data node 240 retrieves parsed OS metrics from a lightweight remote collector circuitry. The parsed OS metric data may then be analyzed to provide a user information on the operation of the cloud resources on which the agent executes.

At block 606, the example master data node 240 transmits parsed metrics to the second data node 242. At block 608, the example master data node 240 transmits a command to configure an application plug-in. The application plug-in may use a password, user credentials, a private key, etc., add a monitoring feature to the application. At block 610, the example master data node 240 retrieves application metrics from the agent. Finally, at block 612, the example master data node 240 transmits the application metrics to the second data node 242.

FIG. 7 is a block diagram of an example processor platform 700 structured to execute and/or instantiate the machine readable instructions and/or the operations of FIGS. 5-6 to implement the lightweight remote collector 148 of FIGS. 1, 2, 3, and/or 4. The processor platform 700 can be, for example, a server, a personal computer, a workstation, a self-learning machine (e.g., a neural network), a mobile device (e.g., a cell phone, a smart phone, a tablet such as an iPad′), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 700 of the illustrated example includes processor circuitry 712. The processor circuitry 712 of the illustrated example is hardware. For example, the processor circuitry 712 can be implemented by one or more integrated circuits, logic circuits, FPGAs, microprocessors, CPUs, GPUs, DSPs, and/or microcontrollers from any desired family or manufacturer. The processor circuitry 712 may be implemented by one or more semiconductor based (e.g., silicon based) devices. In this example, the processor circuitry 712 implements the example metric collection circuitry 302, the example agent lifecycle management circuitry 304, the example data parsing circuitry 306, and the example communication circuitry 308.

The processor circuitry 712 of the illustrated example includes a local memory 713 (e.g., a cache, registers, etc.). The processor circuitry 712 of the illustrated example is in communication with a main memory including a volatile memory 714 and a non-volatile memory 716 by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717.

The processor platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user to enter data and/or commands into the processor circuitry 712. The input device(s) 722 can be implemented by, for example, an audio sensor, a microphone, a camera (still or video), a keyboard, a button, a mouse, a touchscreen, a track-pad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 700 of the illustrated example also includes one or more mass storage devices 728 to store software and/or data. Examples of such mass storage devices 728 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 732, which may be implemented by the machine readable instructions of FIGS. 5-6, may be stored in the mass storage device 728, in the volatile memory 714, in the non-volatile memory 716, and/or on a removable non-transitory computer readable storage medium such as a CD or DVD.

FIG. 8 is a block diagram of an example implementation of the processor circuitry 712 of FIG. 7. In this example, the processor circuitry 712 of FIG. 7 is implemented by a microprocessor 800. For example, the microprocessor 800 may be a general purpose microprocessor (e.g., general purpose microprocessor circuitry). The microprocessor 800 executes some or all of the machine readable instructions of the flowcharts of FIGS. 5-6 to effectively instantiate the lightweight remote collector circuitry 148 of FIG. 3 as logic circuits to perform the operations corresponding to those machine readable instructions. In some such examples, the lightweight remote collector circuitry 148 of FIG. 3 is instantiated by the hardware circuits of the microprocessor 800 in combination with the instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowchart of FIGS. 5-6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating point operations. In yet other examples, the AL circuitry 816 may include first AL circuitry that performs integer based operations and second AL circuitry that performs floating point operations. In some examples, the AL circuitry 816 may be referred to as an Arithmetic Logic Unit (ALU). The registers 818 are semiconductor-based structures to store data and/or instructions such as results of one or more of the operations performed by the AL circuitry 816 of the corresponding core 802. For example, the registers 818 may include vector register(s), SIMD register(s), general purpose register(s), flag register(s), segment register(s), machine specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure including distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 9 is a block diagram of another example implementation of the processor circuitry 712 of FIG. 7. In this example, the processor circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the machine readable instructions in hardware and, thus, can often execute the operations faster than they could be performed by a general purpose microprocessor executing the corresponding software.

More specifically, in contrast to the microprocessor 800 of FIG. 8 described above (which is a general purpose device that may be programmed to execute some or all of the machine readable instructions represented by the flowcharts of FIGS. 5-6 but whose interconnections and logic circuitry are fixed once fabricated), the FPGA circuitry 900 of the example of FIG. 9 includes interconnections and logic circuitry that may be configured and/or interconnected in different ways after fabrication to instantiate, for example, some or all of the machine readable instructions represented by the flowcharts of FIGS. 5-6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the software represented by the flowcharts of FIGS. 5-6. As such, the FPGA circuitry 900 may be structured to effectively instantiate some or all of the machine readable instructions of the flowchart of FIGS. 5-6 as dedicated logic circuits to perform the operations corresponding to those software instructions in a dedicated manner analogous to an ASIC. Therefore, the FPGA circuitry 900 may perform the operations corresponding to the some or all of the machine readable instructions of FIGS. 5-6 faster than the general purpose microprocessor can execute the same.

In the example of FIG. 9, the FPGA circuitry 900 is structured to be programmed (and/or reprogrammed one or more times) by an end user by a hardware description language (HDL) such as Verilog. The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain machine readable instructions to configure the FPGA circuitry 900, or portion(s) thereof. In some such examples, the configuration circuitry 904 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 906 may be implemented by external hardware circuitry. For example, the external hardware 906 may be implemented by the microprocessor 800 of FIG. 8. The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations that may correspond to at least some of the machine readable instructions of FIGS. 5-6 and/or other desired operations. The logic gate circuitry 908 shown in FIG. 9 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example Dedicated Operations Circuitry 914. In this example, the Dedicated Operations Circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the processor circuitry 712 of FIG. 7, many other approaches are contemplated. For example, as mentioned above, modern FPGA circuitry may include an on-board CPU, such as one or more of the example CPU 920 of FIG. 9. Therefore, the processor circuitry 712 of FIG. 7 may additionally be implemented by combining the example microprocessor 800 of FIG. Band the example FPGA circuitry 900 of FIG. 9. In some such hybrid examples, a first portion of the machine readable instructions represented by the flowcharts of FIGS. 5-6 may be executed by one or more of the cores 802 of FIG. 8, a second portion of the machine readable instructions represented by the flowcharts of FIGS. 5-6 may be executed by the FPGA circuitry 900 of FIG. 9, and/or a third portion of the machine readable instructions represented by the flowcharts of FIGS. 5-6 may be executed by an ASIC. It should be understood that some or all of the lightweight remote collector circuitry 148 of FIGS. 1-4 may, thus, be instantiated at the same or different times. Some or all of the circuitry may be instantiated, for example, in one or more threads executing concurrently and/or in series. Moreover, in some examples, some or all of the lightweight remote collector circuitry 148 of FIGS. 1-4 may be implemented within one or more virtual machines and/or containers executing on the microprocessor.

In some examples, the processor circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the processor circuitry 712 of FIG. 7, which may be in one or more packages. For example, the XPU may include a CPU in one package, a DSP in another package, a GPU in yet another package, and an FPGA in still yet another package.

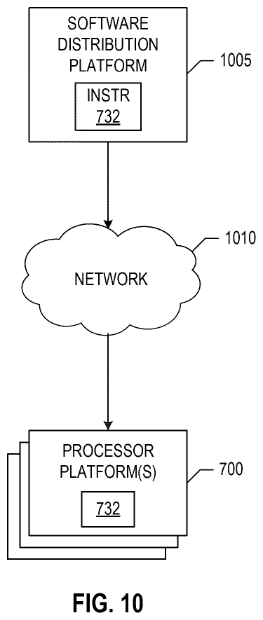

A block diagram illustrating an example software distribution platform 1005 to distribute software such as the example machine readable instructions 732 of FIG. 7 to hardware devices owned and/or operated by third parties is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 705 includes one or more servers and one or more storage devices. The storage devices store the machine readable instructions 732, which may correspond to the example machine readable instructions 500, 600 of FIGS. 5-6, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third-party payment entity. The servers enable purchasers and/or licensors to download the machine readable instructions 732 from the software distribution platform 1005. For example, the software, which may correspond to the example machine readable instructions 500, 600 of FIGS. 5-6, may be downloaded to the example processor platform 700, which is to execute the machine readable instructions 732 to implement the lightweight remote collector circuitry 148 of FIGS. 1-4. In some examples, one or more servers of the software distribution platform 1005 periodically offer, transmit, and/or force updates to the software (e.g., the example machine readable instructions 500, 600 of FIG. 5-6) to ensure improvements, patches, updates, etc., are distributed and applied to the software at the end user devices.

From the foregoing, it will be appreciated that example systems, methods, apparatus, and articles of manufacture have been disclosed that monitor cloud resources with a lightweight collector. Disclosed systems, methods, apparatus, and articles of manufacture improve the efficiency of using a computing device by providing a unified, platform-agnostic monitoring solution to support multi-cloud and/or hybrid cloud platform. Disclosed examples reduce maintenance time due to a lightweight, serverless architecture. Disclosed examples provide improved metric collection and a common platform to monitor on-premises and/or cloud virtual infrastructure.

Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture to monitor cloud resources with a lightweight collector are disclosed herein. Further examples and combinations thereof include the following:

Example 1 includes an apparatus comprising at least one memory, instructions, and processor circuitry to execute the instructions to install an agent on a virtual machine executing in a cloud infrastructure, the agent to transmit information to a serverless application executing in the cloud infrastructure, obtain first metrics from the virtual machine, the first metrics based on an operating system executing on the virtual machine, configure a plug-in of the agent to facilitate monitoring of an application in execution on the virtual machine, obtain second metrics from the virtual machine, the second metrics based on the application, parse the first and second metrics to generate structured analytic data, and transmit the structured analytic data to a server for storage and analysis.

Example 2 includes the apparatus of example 1, wherein the server includes a gateway to receive the structured analytic data, the gateway is to transmit the structured analytic data to a load balancer, and the load balancer is to distribute the structured analytic data to a master data node and a second data node.

Example 3 includes the apparatus of example 2, wherein the cloud infrastructure is a first cloud infrastructure, the agent is a first agent, the virtual machine is a first virtual machine, and further including a second cloud infrastructure, a second agent, and a second virtual machine, wherein the second virtual machine executes on the second cloud infrastructure, the second virtual machine executes a different operating system than the first virtual machine, and wherein the second agent retrieves and parses information from the second virtual machine.

Example 4 includes the apparatus of example 3, wherein the first agent and the second agent generate output in a single structured format.

Example 5 includes the apparatus of example 4, wherein the first or the second metrics are collected from the first virtual machine at a consistent interval.

Example 6 includes the apparatus of example 5, wherein to configure a plug-in of the agent includes providing the agent a port identifier, a user credential, and a database key.

Example 7 includes the apparatus of example 1, wherein the processor circuitry is to execute the instructions to manage a lifecycle of the agent.

Example 8 includes a machine readable storage medium comprising instructions which, when executed cause processor circuitry to execute the instructions to install an agent on a virtual machine, the agent to execute as a serverless application in a cloud infrastructure, obtain first metrics from the virtual machine, the first metrics based on an operating system executing on the virtual machine, configure a plug-in of the agent to facilitate the agent monitoring an application executing on the virtual machine, obtain second metrics from the virtual machine, the second metrics based on the application, parse the first and second metrics, and transmit the first and second metrics to a server for storage and analysis.

Example 9 includes the machine readable storage medium of example 8, wherein the server includes a gateway to receive the first and second parsed metrics, the gateway to transmit the first and second parsed metrics to a load balancer, the load balancer to distribute the first and second metrics to a master data node.

Example 10 includes the machine readable storage medium of example 9, wherein the cloud infrastructure is a first cloud infrastructure, the agent is a first agent, the virtual machine is a first virtual machine, and further including a second cloud infrastructure, a second agent, and a second virtual machine, wherein the second virtual machine executes on the second cloud infrastructure, the second virtual machine executes a different operating system than the first virtual machine, and wherein the second agent retrieves and parses information from the second virtual machine.

Example 11 includes the machine readable storage medium of example 10, wherein the first agent and the second agent parse the metrics to generate an output in a structured format.

Example 12 includes the machine readable storage medium of example 11, wherein metrics are collected from the first virtual machine at consistent intervals.

Example 13 includes the machine readable storage medium of example 12, wherein to configure a plug-in of the agent includes providing the agent a port identifier, a user credential, and a database key.

Example 14 includes the machine readable storage medium of example 9, wherein the processor circuitry is to execute the instructions to manage a lifecycle of the agent.

Example 15 includes a method comprising installing, by executing an instruction with processor circuitry, an agent on a virtual machine, the agent execute as a serverless application in a cloud infrastructure, obtaining, by executing an instruction with the processor circuitry, first metrics from the virtual machine, the first metrics based on an operating system executing on the virtual machine, configuring, by executing an instruction with the processor circuitry, a plug-in of the agent to facilitate the agent monitoring an application executing on the virtual machine, obtaining, by executing an instruction with the processor circuitry, second metrics from the virtual machine, the second metrics based on the application, parsing, by executing an instruction with the processor circuitry, the first and second metrics, and transmitting, by executing an instruction with the processor circuitry, the first and second metrics to a server for storage and analysis.

Example 16 includes the method of example 15, wherein the server includes a gateway to receive the first and second parsed metrics, the gateway to transmit the first and second parsed metrics to a load balancer, the load balancer to distribute the first and second metrics to a master data node.

Example 17 includes the method of example 16, wherein the cloud infrastructure is a first cloud infrastructure, the agent is a first agent, the virtual machine is a first virtual machine, and further including a second cloud infrastructure, a second agent, and a second virtual machine, wherein the second virtual machine executes on the second cloud infrastructure, the second virtual machine executes a different operating system than the first virtual machine, and wherein the second agent retrieves and parses information from the second virtual machine.

Example 18 includes the method of example 17, wherein the first agent and the second agent parse the metrics to generate an output in a structured format.

Example 19 includes the method of example 18, wherein metrics are collected from the first virtual machine at consistent intervals.

Example 20 includes the method of example 19, wherein to configure a plug-in of the agent includes providing the agent a port identifier, a user credential, and a database key. The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

What is claimed is:

1. An apparatus comprising:
at least one memory;
instructions; and
processor circuitry to execute the instructions to:
install an agent on a virtual machine executing in a cloud infrastructure, the agent to transmit information to a serverless application executing in the cloud infrastructure;
obtain first metrics from the virtual machine, the first metrics based on an operating system executing on the virtual machine;
configure a plug-in of the agent to facilitate monitoring of an application in execution on the virtual machine;
obtain second metrics from the virtual machine, the second metrics based on the application;
parse the first and second metrics to generate structured analytic data; and
transmit the structured analytic data to a server for storage and analysis.

2. The apparatus of claim 1, wherein the server includes a gateway to receive the structured analytic data, the gateway is to transmit the structured analytic data to a load balancer, and the load balancer is to distribute the structured analytic data to a master data node and a second data node.

3. The apparatus of claim 2, wherein the cloud infrastructure is a first cloud infrastructure, the agent is a first agent, the virtual machine is a first virtual machine, and further including a second cloud infrastructure, a second agent, and a second virtual machine, wherein the second virtual machine executes on the second cloud infrastructure, the second virtual machine executes a different operating system than the first virtual machine, and wherein the second agent retrieves and parses information from the second virtual machine.

4. The apparatus of claim 3, wherein the first agent and the second agent generate output in a single structured format.

5. The apparatus of claim 4, wherein the first or the second metrics are collected from the first virtual machine at a consistent interval.

6. The apparatus of claim 5, wherein to configure a plug-in of the agent includes providing the agent a port identifier, a user credential, and a database key.

7. The apparatus of claim 1, wherein the processor circuitry is to execute the instructions to manage a lifecycle of the agent.

8. A non-transitory machine readable storage medium comprising instructions which, when executed cause processor circuitry to execute the instructions to:
install an agent on a virtual machine, the agent to execute as a serverless application in a cloud infrastructure;
obtain first metrics from the virtual machine, the first metrics based on an operating system executing on the virtual machine;
configure a plug-in of the agent to facilitate the agent monitoring an application executing on the virtual machine;
obtain second metrics from the virtual machine, the second metrics based on the application;
parse the first and second metrics; and
transmit the first and second metrics to a server for storage and analysis.

9. The non-transitory machine readable storage medium of claim 8, wherein the server includes a gateway to receive the first and second parsed metrics, the gateway to transmit the first and second parsed metrics to a load balancer, the load balancer to distribute the first and second metrics to a master data node.

10. The non-transitory machine readable storage medium of claim 9, wherein the cloud infrastructure is a first cloud infrastructure, the agent is a first agent, the virtual machine is a first virtual machine, and further including a second cloud infrastructure, a second agent, and a second virtual machine, wherein the second virtual machine executes on the second cloud infrastructure, the second virtual machine executes a different operating system than the first virtual machine, and wherein the second agent retrieves and parses information from the second virtual machine.

11. The non-transitory machine readable storage medium of claim 10, wherein the first agent and the second agent parse the metrics to generate an output in a structured format.

12. The non-transitory machine readable storage medium of claim 11, wherein metrics are collected from the first virtual machine at consistent intervals.

13. The non-transitory machine readable storage medium of claim 12, wherein to configure a plug-in of the agent includes providing the agent a port identifier, a user credential, and a database key.

14. The non-transitory machine readable storage medium of claim 9, wherein the processor circuitry is to execute the instructions to manage a lifecycle of the agent.

15. A method comprising:
installing, by executing an instruction with processor circuitry, an agent on a virtual machine, the agent execute as a serverless application in a cloud infrastructure;
obtaining, by executing an instruction with the processor circuitry, first metrics from the virtual machine, the first metrics based on an operating system executing on the virtual machine;
configuring, by executing an instruction with the processor circuitry, a plug-in of the agent to facilitate the agent monitoring an application executing on the virtual machine;
obtaining, by executing an instruction with the processor circuitry, second metrics from the virtual machine, the second metrics based on the application;
parsing, by executing an instruction with the processor circuitry, the first and second metrics; and
transmitting, by executing an instruction with the processor circuitry, the first and second metrics to a server for storage and analysis.

16. The method of claim 15, wherein the server includes a gateway to receive the first and second parsed metrics, the gateway to transmit the first and second parsed metrics to a load balancer, the load balancer to distribute the first and second metrics to a master data node.

17. The method of claim 16, wherein the cloud infrastructure is a first cloud infrastructure, the agent is a first agent, the virtual machine is a first virtual machine, and further including a second cloud infrastructure, a second agent, and a second virtual machine, wherein the second virtual machine executes on the second cloud infrastructure, the second virtual machine executes a different operating system than the first virtual machine, and wherein the second agent retrieves and parses information from the second virtual machine.

18. The method of claim 17, wherein the first agent and the second agent parse the metrics to generate an output in a structured format.

19. The method of claim 18, wherein metrics are collected from the first virtual machine at consistent intervals.

20. The method of claim 19, wherein to configure a plug-in of the agent includes providing the agent a port identifier, a user credential, and a database key.
